(19) United States
(12) Patent Application Publication
(10) Pub. No.: US 2011/0074671 A1
(43) Pub. Date: Mar. 31, 2011

(54) IMAGE DISPLAY APPARATUS AND CONTROL METHOD THEREOF, AND COMPUTER PROGRAM

(75) Inventors: Jiro Shimosato, Tokyo (JP); Katsuhito Yoshio, Tokyo (JP)

(73) Assignee: CANON KABUSHIKI KAISHA, Tokyo (JP)

(21) Appl. No.: 12/994,740

(22) PCT Filed: May 26, 2009
(86) PCT No.: PCT/JP2009/059933

§ 371 Date: Nov. 24, 2010

(30) Foreign Application Priority Data
May 30, 2008 (JP) 2008-143620
Feb. 16, 2009 (JP) 2009-033129

(51) Int. Cl. G09G 5/00

(52) U.S. Cl. 345/156

(57) ABSTRACT

This invention provides a display apparatus which mounts a tilt sensor, and can control whether or not the user makes an image feed operation based on the tilt. An image display apparatus includes a display unit which displays image data recorded in a recording medium, an instruction accepting unit which accepts an instruction to make the image feed operation according to the tilt of the image display apparatus from the user, a tilt detection unit which detects the tilt of the image display apparatus with respect to a predetermined direction, and a display control unit which controls the display unit to display and switch the image data in accordance with a change in tilt detected by the tilt detection unit, when the instruction accepting unit accepts the instruction and the tilt detection unit detects the change in tilt.

### TECHNICAL FIELD

The present invention relates to an image display apparatus and a control method thereof, and a computer program.

### BACKGROUND ART

In recent years, size and profile reductions of portable terminals represented by digital cameras have progressed, and the sizes of operation members tend to be reduced accordingly. More specifically, the operation members include arrow keys, an enter/cancel button, and a display panel used to display images recorded on a recording medium. The user selects a desired image by operating buttons, and displays it on the display panel. However, when the sizes of these button members become smaller, as described above, the user may cause operation errors upon operating the buttons to select an image he or she wants to view.

In recent years, since the capacities of memory cards increase, everyone can easily carry a large number of image data in a portable terminal. Hence, when the user wants to select a desired image from such large number of images by button operations, he or she has to press buttons many times or keep pressing buttons until a desired image is found, resulting in troublesome operations.

To solve this problem, Japanese Patent Laid-Open No. 2007-049484 has proposed a method of playing back a slideshow at a display speed according to the tilt angle of a digital camera including a tilt sensor as the user tilts the digital camera. However, in a digital camera described in Japanese Patent Laid-Open No. 2007-049484, even when the user tilts the digital camera unintentionally, an image feed operation is often executed.

In the digital camera described in Japanese Patent Laid-Open No. 2007-049484, in order to stop an image feed operation while a large number of images are being fed, the user has to stop tilting the digital camera and hold it horizontally. However, it is difficult to return the camera to a horizontal state at the display timing of a desired image.

### DISCLOSURE OF INVENTION

According to exemplary embodiments of the present invention, the present invention relates to an image display apparatus comprising, display means for displaying image data recorded in a recording medium, instruction accepting means for accepting an instruction from a user to switch displayed image data according to a tilt of the image display apparatus, tilt detection means for detecting a tilt of the image display apparatus with respect to a predetermined direction, and display control means for controlling the display means, to switch displayed image data in accordance with the tilt detected by the tilt detection means, when the tilt detection means detects the tilt and the instruction accepting means accepts the instruction, and to rotate image data displayed on the display means in accordance with the tilt detected by the tilt detection means, when the tilt detection means detects the tilt and the instruction accepting means does not accept the instruction.

According to exemplary embodiments of the present invention, the present invention also relates to an image display apparatus comprising, display means for displaying image data recorded in a recording medium, instruction accepting means for accepting an instruction from a user to switch displayed image data according to a tilt of the image display apparatus, tilt detection means for detecting a tilt of the image display apparatus with respect to a predetermined direction, setting means for, when the instruction accepting means accepts the instruction, and the tilt detection means detects a change in tilt of the image display apparatus with respect to the predetermined direction from the tilt at an accepting timing of the instruction by the instruction accepting means, setting a speed required to switch displayed image data in accordance with a change amount of the tilt, and display control means for controlling the display means to switch displayed image data at the speed set by the setting means.

According to exemplary embodiments of the present invention, the present invention further relates to a method of controlling an image display apparatus, comprising, a display step of displaying image data recorded in a recording medium on display means, an instruction accepting step of accepting an instruction from a user to switch displayed image data according to a tilt of the image display apparatus, a tilt detection step of detecting a tilt of the image display apparatus with respect to a predetermined direction, and a display control step of controlling the display means, to switch displayed image data in accordance with the tilt detected in the tilt detection step, when the tilt is detected in the tilt detection step and the instruction is accepted in the instruction accepting step, and to rotate image data displayed on the display means in accordance with the tilt detected in the tilt detection step, when a tilt is detected in the tilt detection step and the instruction is not accepted in the instruction accepting step.

According to exemplary embodiments of the present invention, the present invention further relates to a computer program stored in a computer-readable storage medium to make a computer function as an image display apparatus, the image display apparatus comprising, display means for displaying image data recorded in a recording medium, instruction accepting means for accepting an instruction from a user to switch displayed image data according to a tilt of the image display apparatus, tilt detection means for detecting a tilt of the image display apparatus with respect to a predetermined direction, and display control means for controlling the display means, to switch displayed image data in accordance with the tilt detected by the tilt detection means, when the tilt detection means detects the tilt and the instruction accepting means accepts the instruction, and to rotate image data displayed on the display means in accordance with the tilt detected by the tilt detection means, when the tilt detection means detects the tilt and the instruction accepting means does not accept the instruction.

According to exemplary embodiments of the present invention, the present invention relates to a method of controlling an image display apparatus, comprising, a display step of displaying image data recorded in a recording medium on display means, an instruction accepting step of accepting an instruction from a user to switch displayed image data according to a tilt of the image display apparatus, a tilt detection step of detecting a tilt of the image display apparatus with respect to a predetermined direction, a setting step of setting, when the instruction is accepted in the instruction accepting step, and a change in tilt of the image display apparatus with respect to the predetermined direction from the tilt at an accepting timing of the instruction in the instruction accepting step is detected in the tilt detection step, a speed required to switch displayed image data in accordance with a change amount of the tilt, and a display control step of controlling the display means to switch displayed image data at the speed set in the setting step.

According to exemplary embodiments of the present invention, the present invention further relates to a computer program stored in a computer-readable storage medium to make a computer function as an image display apparatus, the image display apparatus comprising, display means for displaying image data recorded in a recording medium, instruction accepting means for accepting an instruction from a user to switch displayed image data according to a tilt of the image display apparatus, tilt detection means for detecting a tilt of the image display apparatus with respect to a predetermined direction, setting means for, when the instruction accepting means accepts the instruction, and the tilt detection means detects a change in tilt of the image display apparatus with respect to the predetermined direction from the tilt at an accepting timing of the instruction by the instruction accepting means, setting a speed required to switch displayed image data in accordance with a change amount of the tilt, and display control means for controlling the display means to switch displayed image data at the speed set by the setting means.

Further features of the present invention will become apparent from the following description of exemplary embodiments (with reference to the attached drawings).

### BRIEF DESCRIPTION OF DRAWINGS

FIG. 1 is a block diagram showing an example of the hardware arrangement of a digital camera 100 according to an embodiment of the invention;

FIG. 2A is a view showing an example of the arrangement of the outer appearance of the digital camera 100 according to the embodiment of the invention;

FIG. 2B is a view for explaining a tilt of the digital camera 100 according to the first embodiment of the invention;

FIG. 3 is a flowchart showing an example of processing in the digital camera 100 according to the embodiment of the invention;

FIGS. 4A and 4B are views showing examples of a guidance screen according to the embodiment of the invention;

FIG. 5 is a table showing the relationship between image data stored in a recording medium 200 or 210 and the display order according to the embodiment of the invention;

FIGS. 6A and 6B are views showing a display example of image data according to the embodiment of the invention;

FIG. 7A is a flowchart showing an example of processing for adjusting the display time of image data according to the difference between tilt angles (display time adjustment processing 1) according to the embodiment of the invention;

FIG. 7B is a table showing the correspondence between the difference between tilt angles and a display time according to the first embodiment of the invention;

FIG. 8A is a flowchart showing an example of processing for adjusting the display time of image data according to the duration time of a tilt state (display time adjustment processing 2) according to the embodiment of the invention;

FIG. 8B is a table showing the correspondence between the duration time of a tilt state and a display time according to the embodiment of the invention;

FIGS. 9A and 9B are views showing another display example of image data according to the embodiment of the invention;

FIGS. 10A to 10C are flowcharts for explaining an image feed operation according to the second embodiment of the invention;

FIG. 11 is a view for explaining a tilt of the digital camera 100 according to the second embodiment of the invention; and

FIG. 12 is a table showing the correspondence between the difference between tilt angles and a display time according to the second embodiment of the invention.

### BEST MODE FOR CARRYING OUT THE INVENTION

Embodiments of the invention will be described hereinafter with reference to the drawings. More specifically, the embodiments of the invention will be described hereinafter taking a digital camera which can sense and display still images and to which the invention is applied as an example.

### First Embodiment

The first embodiment will exemplify a case in which an image feed operation can be made according to the tilt of a digital camera when he or she touches a touch panel arranged on a display for displaying an image, and is inhibited in other cases even when the digital camera is tilted.

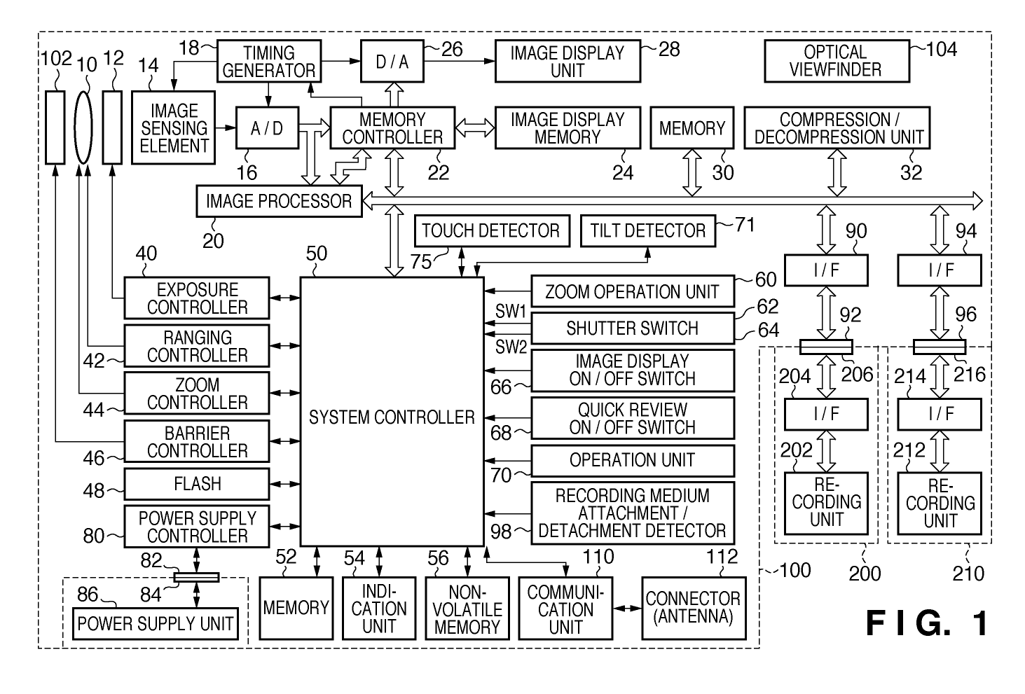

FIG. 1 is a block diagram showing an example of the hardware arrangement of a digital camera as an example of the arrangement of an image display apparatus according to an embodiment of the invention.

A digital camera 100 is configured to sense an object image via an optical system (image sensing lens) 10. The optical system 10 is configured as a zoom lens (a lens that can change an image sensing field angle). As a result, an optical zoom function (so-called optical zoom) is provided. Furthermore, the digital camera 100 is configured to have a digital zoom function (so-called digital zoom) by digitally trimming an image sensed by an image sensing element 14.

Note that the digital camera 100 is configured to have either one of the optical and digital zoom functions in some cases. The optical system 10 may be interchangeable. In this case, the main body side of the digital camera 100 transmits an electrical signal to the optical system 10, so that a drive mechanism in the optical system 10 drives a zoom lens, thereby providing a zoom function. Alternatively, a drive mechanism which mechanically drives a zoom lens in the optical system 10 may be provided to the main body side of the digital camera 100.

Light rays which come from an object and pass through the optical system (image sensing lens) 10 (light rays coming from within an optical field angle) form an optical image of the object on the image sensing plane of the image sensing element (for example, a CCD sensor or CMOS sensor) 14 via an opening of a shutter 12 having an aperture function. The image sensing element 14 converts this optical image into an electrical analog image signal, and outputs the electrical analog image signal. An A/D converter 16 converts the analog image signal supplied from the image sensing element 14 into a digital image signal. The image sensing element 14 and A/D converter 16 are controlled by clock signals and control signals supplied from a timing generator 18. The timing generator 18 is controlled by a memory controller 22 and system controller 50.

The system controller 50 controls the overall image processing apparatus 100. An image processor 20 applies image processing such as pixel interpolation processing and color conversion processing to image data (digital image data) supplied from the A/D converter 16 or that supplied from the memory controller 22. Based on image data sensed by the image sensing element 14, the image processor 20 calculates data for TTL (through-the-lens) AF (auto focus) processing, AE (auto exposure) processing, and EF (automatic light control based on flash pre-emission) processing. The image processor 20 supplies this calculation result to the system controller 50.

The system controller 50 controls an exposure controller 40 and ranging controller (AF controller) 42 based on this calculation result, thus implementing the auto exposure and auto focus functions. Furthermore, the image processor 20 also executes TTL AWB (auto white balance) processing based on image data sensed by the image sensing element 14.

The memory controller 22 controls the A/D converter 16, the timing generator 18, the image processor 20, an image display memory 24, a D/A converter 26, a memory 30, and a compression/decompression unit 32. Image data output from the A/D converter 16 is written in the image display memory 24 or memory 30 via the image processor 20 and memory controller 22 or via the memory controller 22 without the intervention of the image processor 20.

Display image data written in the image display memory 24 is converted into a display analog image signal by the D/A converter 26, and the analog image signal is supplied to an image display unit 28, thus displaying a sensed image on the image display unit 28.

By continuously displaying a sensed image on the image display unit 28, an electronic viewfinder function is implemented. Display of the image display unit 28 can be arbitrarily turned on/off in response to a display control instruction from the system controller 50. When the image display unit 28 is used while its display is kept off, the consumption power of the digital camera 100 can be greatly reduced. The image display unit 28 includes a liquid crystal panel or organic EL panel, and can form a touch panel together with a touch detector 75 to be described later.

The memory 30 is used to store sensed still images and moving images (sensed as those to be recorded in a recording medium). The capacity and access speed (write and read speeds) of the memory 30 can be arbitrarily determined. However, in order to attain a continuous-shot or panorama image sensing mode that continuously senses a plurality of still images, the memory 30 is required to have a capacity and access speed corresponding to the mode. The memory 30 can also be used as a work area of the system controller 50.

The compression/decompression unit 32 compresses/decompresses image data by, for example, adaptive discrete cosine transformation (ADCT). The compression/decompression unit 32 executes compression or decompression processing by loading image data stored in the memory 30, and writes the processed image data in the memory 30.

The exposure controller 40 controls the shutter 12 having the aperture function based on information supplied from the system controller 50. The exposure controller 40 can also have a flash light control function in cooperation with a flash (emission device) 48. The flash 48 has a flash light control function and an AF auxiliary light projection function.

The ranging controller 42 controls a focusing lens of the optical system 10 based on information supplied from the system controller 50. A zoom controller 44 controls zooming of the optical system 10. A barrier controller 46 controls the operation of a barrier 102 used to protect the optical system 10.

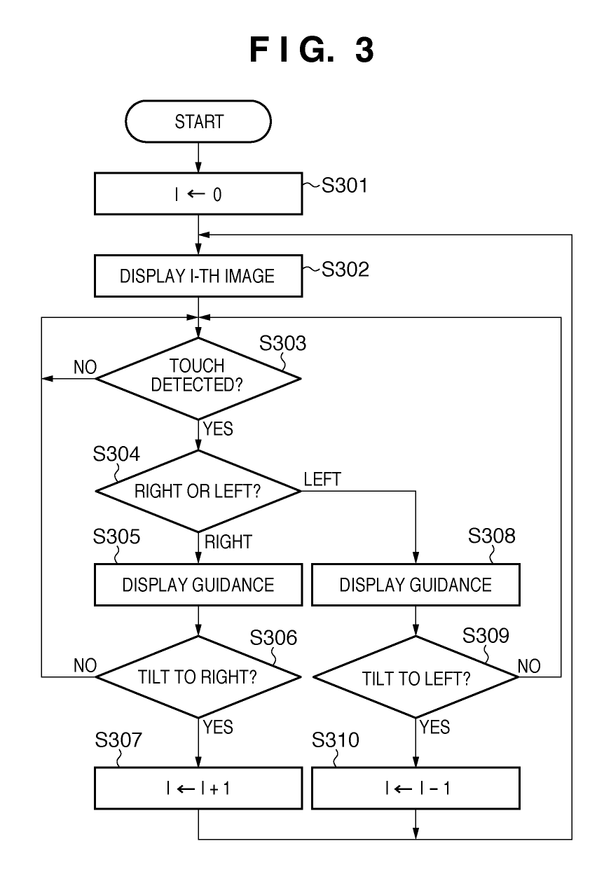

A memory 52 includes, for example, a ROM which stores constants, variables, programs, and the like required for the operation of the system controller 50. The memory 52 stores a program for implementing image sensing processing, that for implementing image processing, that for recording created image file data on a recording medium, and that for reading out image file data from the recording medium. Also, the memory 52 records various programs shown in the flowcharts of FIGS. 3, 7A, and 8A, and an OS which implements and executes a multi-task configuration of the programs. Message queues are created for respective programs, and messages are enqueued in these message queues in a FIFO (First In First Out) manner. The programs exchange messages to be cooperatively controlled, thus controlling the respective functions.

Each of an indication unit (for example, an LCD and LEDs) 54 and sound source (for example, a loudspeaker) includes one or a plurality of elements. These units are configured to output an operation status, messages, and the like by means of text, images, sounds, and the like in accordance with execution of the programs by the system controller 50, and are laid out at appropriate positions of the image processing apparatus 100.

Some indication elements of the indication unit 54 can be arranged inside an optical viewfinder 104. Of information indicated on the indication unit 54, information indicated on an LCD or the like includes, for example, a single-/continuous-shot indication, self-timer indication, compression ratio indication, recording pixel count indication, recorded image count indication, remaining recordable image count indication, and shutter speed indication. Also, the information includes an aperture value indication, exposure correction indication, flash indication, red-eye reduction indication, macro-shot indication, buzzer setting indication, clock battery remaining amount indication, battery remaining amount indication, error indication, plural-digit numerical information indication, and attached/detached state indication of recording media 200 and 210. Furthermore, the information includes a communication I/F operation indication, date/time indication, and image sensing mode/information code read mode indication.

Of the information indicated on the indication unit 54, information indicated in the optical viewfinder 104 includes, for example, an in-focus indication, camera-shake warning indication, flash charging indication, shutter speed indication, aperture value indication, and exposure correction indication.

A nonvolatile memory 56 is an electrically erasable/recordable memory such as an EEPROM. Image data and object data from an external device may be stored in the nonvolatile memory 56.

A zoom operation unit 60 is operated by a photographer to change the image sensing field angle (zoom or image sensing scale). For example, the zoom operation unit 60 can be formed by a slide- or lever-type operation member, and a switch or sensor used to detect its operation. In this embodiment, an image is displayed to be enlarged or reduced in size by the zoom operation unit 60 in a play mode.

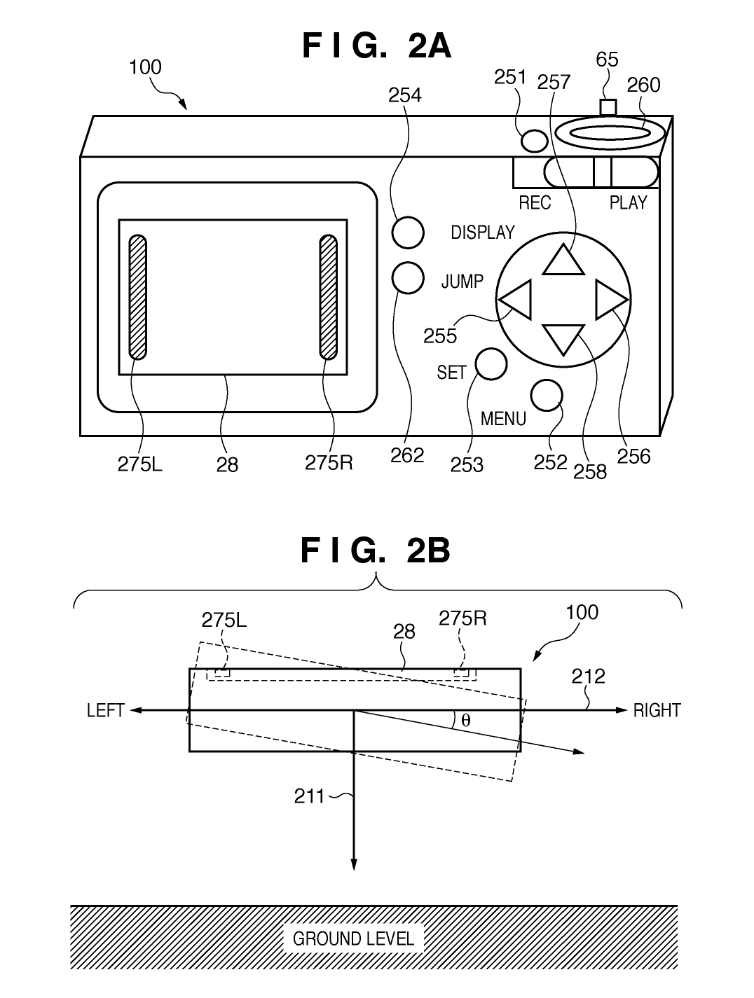

A first shutter switch (SW1) 62 is turned on in the middle of an operation (at the half stroke position) of a shutter button (a shutter button 260 in FIG. 2A). In this case, this ON operation instructs the system controller 50 to start the AF (auto focus) processing, AE (auto exposure) processing, AWB (auto white balance) processing, EF (flash pre-emission) processing, and the like. A second shutter switch (SW2) 64 is turned on upon completion of the operation (at the full stroke position) of the shutter button (the shutter button 260 in FIG. 2A). In this case, this ON operation instructs the system controller 50 to start processing for reading out an image signal from the image sensing element 14, converting the readout image signal into digital image data by the A/D converter 16, processing the digital image data by the image processor 20, and writing the processed image data in the memory 30 via the memory controller 22. Also, this ON operation instructs the system controller 50 to start a series of processes (image sensing) including processing for compressing image data read out from the memory 30 by the compression/decompression unit 32, and writing the compressed image data in the recording medium 200 or 210.

An image display ON/OFF switch 66 is used to set ON/OFF of the image display unit 28. Using this function, power savings can be achieved by cutting off current supply to the image display unit 28 including a TFT LCD upon sensing an image using the optical viewfinder 104. A quick review ON/OFF switch 68 is used to set a quick review function of automatically playing back sensed image data immediately after image sensing.

An operation unit 70 is operated when the user turns on/off a power switch, sets or change image sensing conditions, confirms the image sensing conditions, confirms the status of the digital camera 100, and confirms sensed images. The operation unit 70 can include buttons or switches 251 to 262 shown in FIG. 2A.

A tilt detector 71 detects the tilt angle of the digital camera 100 with respect to a predetermined direction, and notifies the system controller 50 of the detected angle. The tilt detector 71 can include, for example, an acceleration sensor, and an angle analysis circuit which analyzes the output from the acceleration sensor, and calculates a tilt. The tilt detector 71 keeps detecting the tilt angle of the digital camera 100 while the digital camera 100 is ON or while the digital camera 100 is in a power saving mode, and notifies the system controller 50 of the tilt detection result.

The touch detector 75 has at least two touch sensors. When it is determined that the user touches one touch sensor, the touch detector 75 notifies the system controller 50 of the touched sensor. For example, this touch detector 75 is arranged on the image display unit 28, and various different processes are executed according to the touched sensors, thus realizing a touch panel. Note that the touch detector 75 need not always be arranged on the image display unit 28, but it can be laid out on portions where it is easy for the user to operate of the housing of the digital camera 100.

A power supply controller 80 includes, for example, a power supply detector, DC-DC converter, and switch unit used to switch blocks to be energized, and detects the presence/absence and type of a power supply, and the battery remaining amount. The power supply controller 80 controls the DC-DC converter in accordance with the detection result and an instruction from the system controller 50, and supplies required voltages to respective blocks for required time periods. The main body of the digital camera 100 and a power supply 86 respectively have connectors 82 and 84, and are connected to each other via these connectors. The power supply 86 includes, for example, a primary battery such as an alkali battery or lithium battery, a secondary battery such as an NiCd battery, NiMH battery, or Li battery, and an AC adapter.

The recording media 200 and 210 are connected to connectors 92 and 96 of the main body of the digital camera 100 via connectors 206 and 216, respectively. The recording media 200 and 210 respectively include, for example, recording units 202 and 212 such as semiconductor memories or hard disks, and interfaces 204 and 214, and are connected to a bus in the digital camera 100 via interfaces 90 and 94 on the main body side of the digital camera 100. A recording medium attachment/detachment detector 98 detects whether or not the recording media 200 and 210 are connected to the connectors 92 and 96, respectively.

Note that in the description of this example, the digital camera 100 includes two sets of interfaces and connectors used to attach recording media. However, the digital camera 100 may include one set or three or more sets. When the digital camera 100 includes a plurality of sets of interfaces and connectors, they may have different specifications. As these interfaces and connectors, those which comply with, for example, the standards of PCMCIA cards or CF (CompactFlash™) cards can be adopted.

The interfaces 90 and 94 and connectors 92 and 96 can adopt those which comply with, for example, the standards of PCMCIA cards or CF (CompactFlash™) cards. For example, various kinds of communication cards such as a LAN card, modem card, USB card, IEEE1394 card, P1284 card, SCSI card, and PHS card can be connected. As a result, the digital camera 100 can exchange image data and management information appended to the image data with other computers or peripheral devices such as a printer.

The optical viewfinder 104 allows the user to sense an image without using the electronic viewfinder function by means of the image display unit 28. In the optical viewfinder 104, some indication elements of the indication unit 54, for example, those used to make an in-focus indication, camera-shake warning indication, flash charging indication, shutter speed indication, aperture value indication, and exposure correction indication may be arranged.

The digital camera 100 has a communication unit 110, which provides various communication functions such as USB, IEEE1394, P1284, SCSI, modem, LAN, RS232C, and wireless communication functions. To the communication unit 110, a connector 112 used to connect the digital camera 100 to another device or an antenna in case of a wireless communication function may be connected.

FIG. 2A is a view showing an example of the arrangement of the outer appearance of the digital camera 100. Note that FIG. 2A does not illustrate components which are not required for a description.

A power button 251 is used to start or stop the digital camera 100 or to turn on/off a main power supply of the digital camera 100. A menu button 252 is used to display a menu (which includes a plurality of selectable items and/or those, the values of which can be changed) required to set various image sensing conditions and to display the status of the digital camera 100.

Note that settable modes or items include, for example, an image sensing mode (a program mode, aperture priority mode, and shutter speed priority mode in association with determination of exposure), a panorama image sensing mode, and an information code read mode. Also, the modes or items include a play mode, multi-window play/delete mode, PC connection mode (a PC is a computer such as a personal computer), exposure correction, and flash setting. Furthermore, the modes or items include switching of a single-/continuous-shot, a self timer setting, recording image quality setting, date & time setting, and protection of recorded images.

For example, when the user presses the menu button 252, the system controller 50 displays the menu on the image display unit 28. The menu may be displayed to be composited on an image to be sensed, or solely (for example, on a predetermined background color). When the user presses the menu button 252 again while the menu is displayed, the system controller 50 quits displaying the menu on the image display unit 28.

On the image display unit 28, first and second touch sensors 275R and 275L are laid out, and detect touches when the user's fingers touch the surfaces of these sensors. When the image display unit 28 has a rectangular shape defined by four sides, the first touch sensor 275R is laid out in association with the right side of the image display unit 28, and generally detects a touch by a finger of the right hand of the user. Also, the second touch sensor 275L is laid out in association with the left side of the image display unit 28, and generally detects a touch by a finger of the left hand of the user. Note that words “first” and “second” are appended to discriminate the touch sensors 275R and 275L from each other for the sake of convenience, and reference numeral 275L may denote a first touch sensor. In the following description, words “first” and “second” may often be omitted for the sake of simplicity.

Assume that the upper, lower, right, and left directions in this embodiment are defined as follows. In a state shown in FIG. 2A in which the image display unit 28 of the digital camera 100 faces the user side, a direction on the user's right side of the image display unit 28 is called “right”, and a direction on the user's left side is called “left”. Also, a direction on the user's upper side of the image display unit 28 is called “upper”, and a direction on the user's lower side is called “lower”. Note that FIG. 2A shows a case in which the touch sensors are laid out on the two, right and left positions of the image display unit 28. The layout positions and number of touch sensors are not limited to those, and the touch sensors may be laid out on the upper and lower positions, four corners of the screen, or on the entire screen.

An enter button 253 is pressed upon settling or selecting a mode or item. Upon pressing the enter button 253, the system controller 50 sets a mode or item selected at that time. A display button 254 is used to select display/non-display of image sensing information about a sensed image and to switch whether or not the image display unit 28 serves as an electronic viewfinder.

A left button 255, right button 256, up button 257, and down button 258 (direction selection keys) can be used to change a selected one (for example, an item or image) of a plurality of options such as a cursor or highlighted part. Alternatively, these buttons 255 to 258 can be used to change the position of an index that specifies the selected option or to increment/decrement a numerical value (for example, a numerical value indicating a correction value or date and time). Also, upon playing back images in the play mode, the left button 255 and right button 256 can be used as image feed buttons. That is, upon pressing the left button 255, a currently displayed image is switched to an immediately preceding image. Upon pressing the right button 256, a currently displayed image is switched to a next image.

Note that it is able to configure a user interface that allows selecting two or more items in addition to selection of only one item from a plurality of items by the left button 255, right button 256, up button 257, and down button 258. For example, when the user operates the left button 255, right button 256, up button 257, or down button 258 while he or she holds down the enter button 253, the system controller 50 can recognize that two or more items designated by that operation are selected.

As described above, the shutter button 260 in, for example, the half stroke state instructs the system controller 50 to start the AF (auto focus) processing, AE (auto exposure) processing, AWB (auto white balance) processing, EF (flash pre-emission) processing, and the like. Also, the shutter button 260 in the full stroke state instructs the system controller 50 to sense an image. A recording/play switch 261 is used to switch a recording mode to the play mode and vice versa.

A jump key 262 has the same function as the direction selection keys, and is used to change a selected one (for example, an item or image) of a plurality of options such as a cursor or highlighted part. Alternatively, the jump key 262 may be used to change the position of an index that specifies a selected option. The cursor movement by means of the jump key may be set to be quicker or larger than that by the direction selection keys. Note that a dial switch may be adopted in place of the aforementioned operation system, and other operation systems may be adopted.

FIG. 2B is a view for explaining a tilt of the digital camera. Assume that in FIG. 2B, the digital camera 100 is held to face a horizontal direction 212 perpendicular to a vertical direction 211 facing the ground level. At this time, the image display unit 28 of the digital camera 100 is parallel to the horizontal direction 212, and is located on the face opposite to the ground level.

In this state, when the user lowers the right side (the side where the touch sensor 275R is laid out) of the digital camera 100 toward the vertical direction 211, and raises the left side in a direction opposite to the vertical direction, the digital camera 100 has a tilt angle θ with respect to the horizontal direction. The tilt detector 71 detects this angle θ, and notifies the system controller 50 of the detected angle.

The angle θ allows detecting a change in first tilt by assigning a positive sign when the digital camera 100 is tilted clockwise in FIG. 2B. Also, the angle θ allows detecting a change in second tilt by assigning a negative sign when the digital camera 100 is tilted counterclockwise in FIG. 2B. Note that the signs assigned to the change in first tilt and that in the second tilt may be reversed. When a positive sign is assigned to the angle θ, it is assumed that the digital camera is tilted to the right. On the other hand, when a negative sign is assigned to the angle θ, it is assumed that the digital camera is tilted to the left.

Note that it is rare to hold the digital camera 100 to be perfectly parallel to the ground level in its actual use state. Even in such case, the system controller 50 can detect a change in angle θ based on the angle θ detected by the tilt detector 71. Then, the system controller 50 can determine based on the degree of change whether or not the digital camera 100 is tilted, and a direction in which the digital camera 100 is tilted.

Upon using the digital camera 100, the user normally faces the image display unit 28. Therefore, when the digital camera 100 is tilted, as described above, one of the sides that define the image display unit 28 is located to be separated from the user side. For example, a case will be examined below wherein the image display unit 28 has a rectangular shape defined by the four, upper, lower, right, and left sides. At this time, when the user tilts the digital camera 100 to the right side, the right side is located to be separated from the user; when he or she tilts the digital camera 100 to the left side, the left side as the opposite side of the right side is located to be separated from the user.

FIG. 3 is a flowchart for explaining an image feed operation according to this embodiment. Processing corresponding to this flowchart is implemented when the system controller 50 executes a corresponding processing program stored in the memory 52.

When the digital camera 100 is activated in the play mode, the system controller 50 resets a counter I indicating the display order of images to zero in step S301. In step S302, the system controller 50 reads out the 0th image from the memory 30 and displays the readout image. In this case, if the counter of the previously displayed image is recorded on the nonvolatile memory 56, the system controller 50 may extract that counter I, and may display the corresponding image.

The system controller 50 checks in step S303 if the touch detector 75 detects a touch while the I-th image is displayed. If a touch is detected (“YES” in step S303), the process advances to step S304. If no touch is detected (“NO” in step S303), the process returns to step S302 to continue to display the I-th image.

The system controller 50 checks in step S304 if either of the plurality of contact sensors 275L and 275R detects a touch. If the contact sensor 275R detects a touch (“right” in step S304), the process advances to step S305. On the other hand, if the contact sensor 275L detects a touch (“left” in step S304), the process advances to step S308.

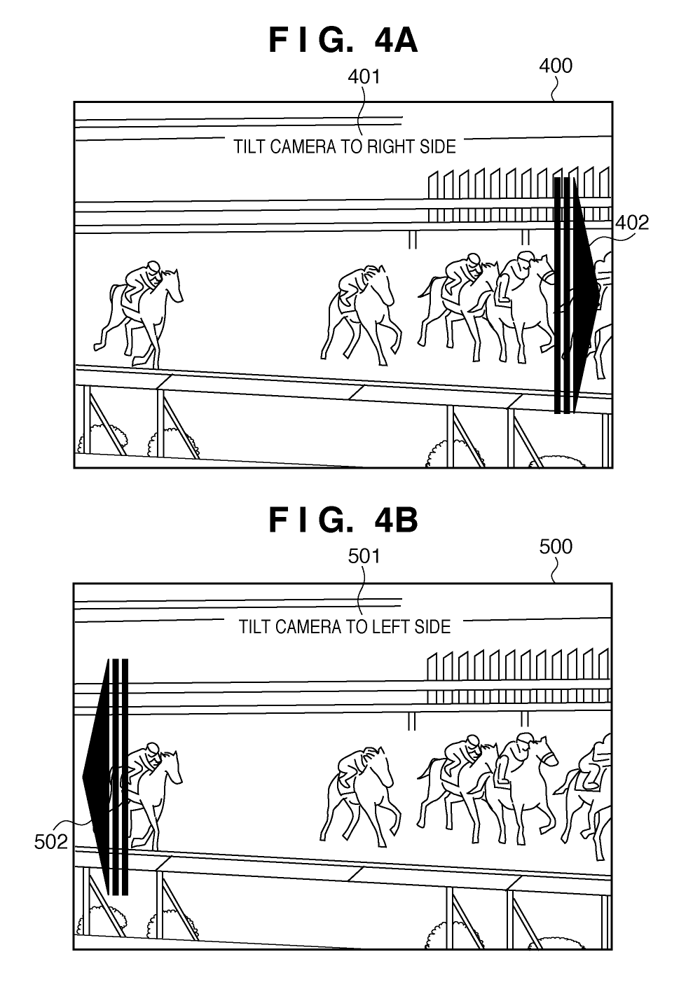

In step S305, the system controller 50 displays guidance information on an arbitrary area of the image display unit 28. FIG. 4A shows an example of display of the guidance information at this time. In FIG. 4A, a photo 400 is an image displayed on the image display unit 28. An area 401 displays text information “tilt camera to right side”. At the same time, the image display unit 28 displays a graphic 402 indicating the right direction corresponding to the text information in the area 401.

The system controller 50 detects in step S306 based on the output from the tilt detector 71 if the user tilts the digital camera 100 to the right side according to the guidance. At this time, the tilt detector 71 detects the tilt of the digital camera 100 in the right or left direction from the horizontal direction, and notifies the system controller 50 of the detected angle.

If it is detected that the digital camera 100 is tilted to the right (“YES” in step S306), the process advances to step S307. On the other hand, if it is determined that the digital camera 100 is not tilted to the right (“NO” in step S306), the process returns to step S303 to continue the processing.

In step S307, the system controller 50 increments the value of the counter I by one, and the process returns to step S302 to display the corresponding image. In this manner, when the user tilts the digital camera to the right side while touching the right side, image data to be displayed is switched according to the display order, thus displaying a forward feed slideshow.

If the touch sensor 275L detects a touch, and the process advances to step S308, the system controller 50 displays guidance information on an arbitrary area of the image display unit 28 in step S308. FIG. 4B shows an example of display of the guidance information at this time. In FIG. 4B, a photo 500 is an image displayed on the image display unit 28. An area 501 displays text information “tilt camera to left side”. At the same time, the image display unit 28 displays a graphic 502 indicating the left direction corresponding to the text information in the area 501.

The system controller 50 detects in step S309 based on the output from the tilt detector 71 if the user tilts the digital camera 100 to the left side according to the guidance. At this time, the tilt detector 71 detects the tilt of the digital camera 100 in the right or left direction from the horizontal direction, and notifies the system controller 50 of the detected angle.

If it is detected that the digital camera 100 is tilted to the left (“YES” in step S309), the process advances to step S310. On the other hand, if it is determined that the digital camera 100 is not tilted to the left (“NO” in step S309), the process returns to step S303 to continue the processing.

In step S310, the system controller 50 decrements the value of the counter I by one, and the process returns to step S302 to display the corresponding image. In this manner, when the user tilts the digital camera to the left side while touching the left side, image data to be displayed is switched according to an order reverse to the display order, thus displaying a reverse feed slideshow.

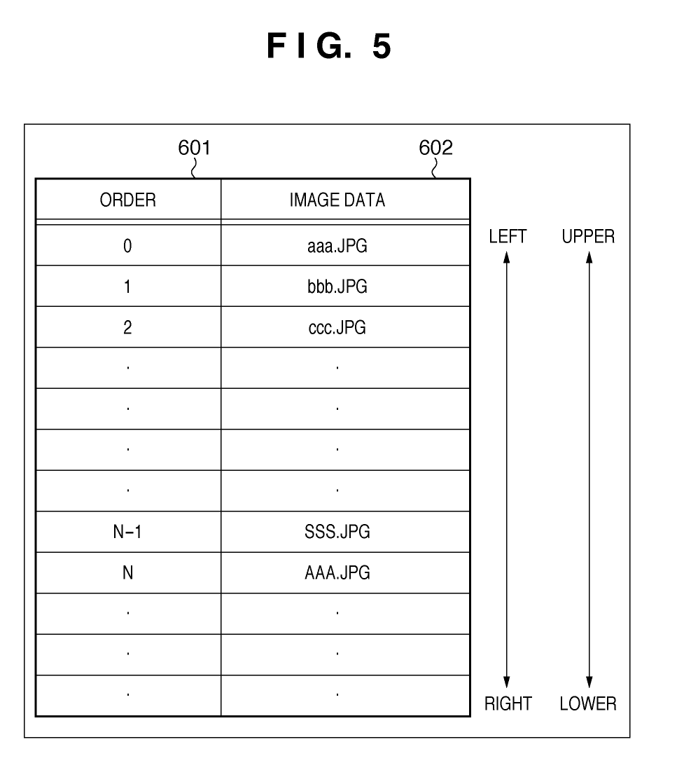

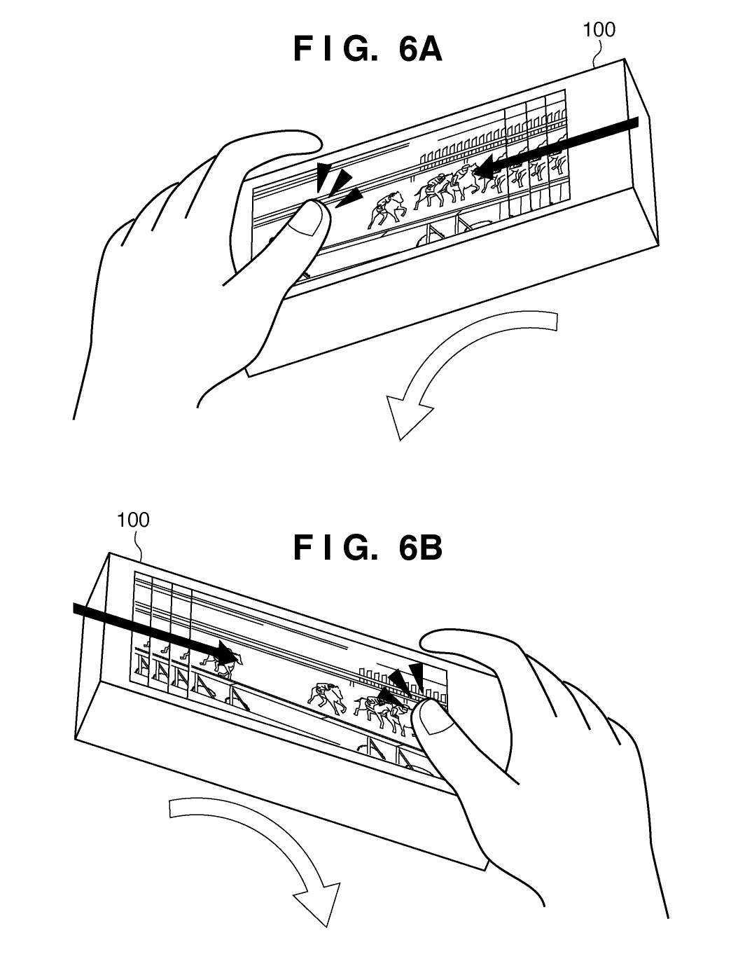

The concept of the aforementioned operation will be described below with reference to FIG. 5 and FIGS. 6A and 6B. FIG. 5 shows the relationship between image data stored in the recording medium 200 or 210 and their display order. In FIG. 5, an order 601 indicates a display order. This order 601 corresponds to the value of the counter I reset in step S301 in FIG. 3. That is, I=0 corresponds to “0” in the order 601. The order 601 may be set to be 0, 1, . . . in descending order or ascending order of photographing date and time. The user can arbitrarily set assignment of this order 601. Image data 602 stores information of image data to which the orders are assigned. FIG. 5 shows the names of image data as an example, but image data can be managed as well as their storage locations.

According to the processing shown in FIG. 3 for the image data assigned the orders, when the touch sensor 275R detects a touch, and the digital camera is tilted to the right side, image data are selected while the order 601 is incremented one by one like 0, 1, 2, . . . . On the other hand, when the touch sensor 275L detects a touch, and the digital camera is tilted to the left side, image data are selected while the order 601 is decremented one by one like N, N−1, N−2, . . . . The selected image data is read out from the memory 30, and is displayed on the image display unit in the form of FIG. 4A. Note that the same applies to a case in which the tilt direction is the up or down direction in addition to the right or left direction.

FIG. 6A shows a case in which the reverse feed operation is made. In this case, the digital camera 100 is held so that the image display unit 28 is nearly parallel to the ground level and faces up, and the left side of the main body is tilted in the ground level direction. FIG. 6B shows a case in which the forward feed operation is made. In this case, the right side of the digital camera 100 is tilted in the ground level direction.

The tilt detector 71 stores a tilt angle θ₀ in the right or left direction when the touch detector 75 is touched first time. Then, the tilt detector 71 may notify the system controller 50 of a difference θ_{d} between the tilt angle θ₀ and a tilt angle θ₁ after that as the tilt of the camera 100. As a result, when the user activates the camera while the camera has a large tilt in either the right or left direction, an easy image search operation is allowed without disturbing an image feed operation.

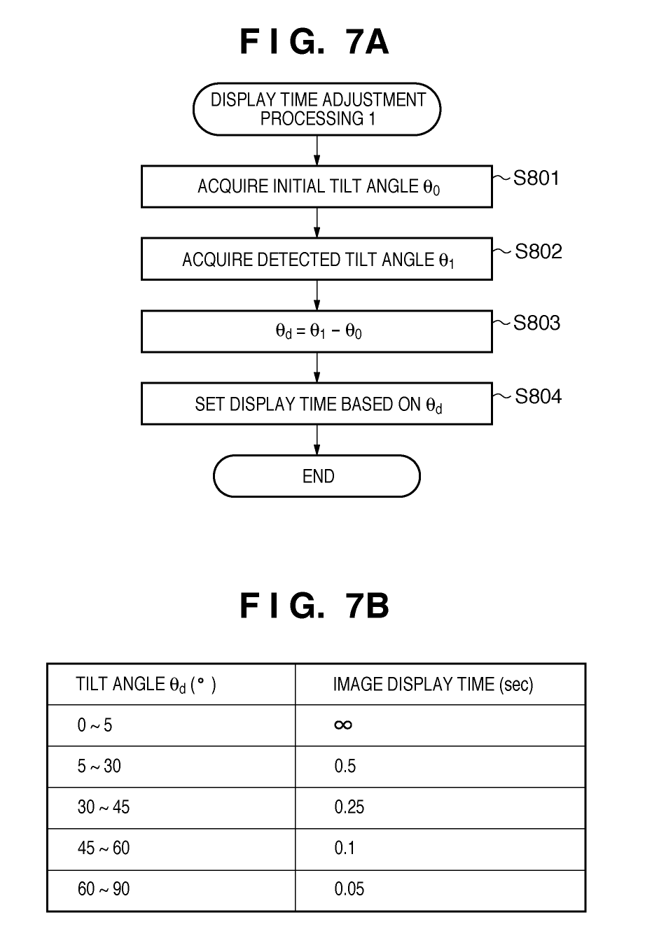

The display time of an image in step S302 may be adjusted based on the difference between the tilt angles. The image display time adjustment processing will be described below with reference to FIGS. 7A and 7B. FIG. 7A is a flowchart showing an example of processing for adjusting the display time of image data in accordance with the difference between tilt angles (display time adjustment processing 1). FIG. 7B is a table showing the correspondence between the differences between the tilt angles and the display times. A lookup table 810 shown in FIG. 7B can be stored in advance in the digital camera 100 (for example, the nonvolatile memory 56).

Referring to FIG. 7A, the system controller 50 acquires an angle θ₀ detected by the tilt detector 71 when the touch detector 75 detects a touch in step S801. In step S802, the system controller 50 acquires an angle θ₁ detected later from the tilt detector 71. In step S803, the system controller 50 calculates a difference θ_{d} between the detected angles θ₁ and θ₀. In step S804, the system controller 50 acquires a display time from the table shown in FIG. 7B based on the difference θ_{d}, and sets it as the display time of image data.

In FIG. 7B, the display time of each image data is shortened with increasing tilt angle. Therefore, when the user tilts the digital camera 100 deeper, since images are fed quicker, the user can make an image feed operation more intuitively.

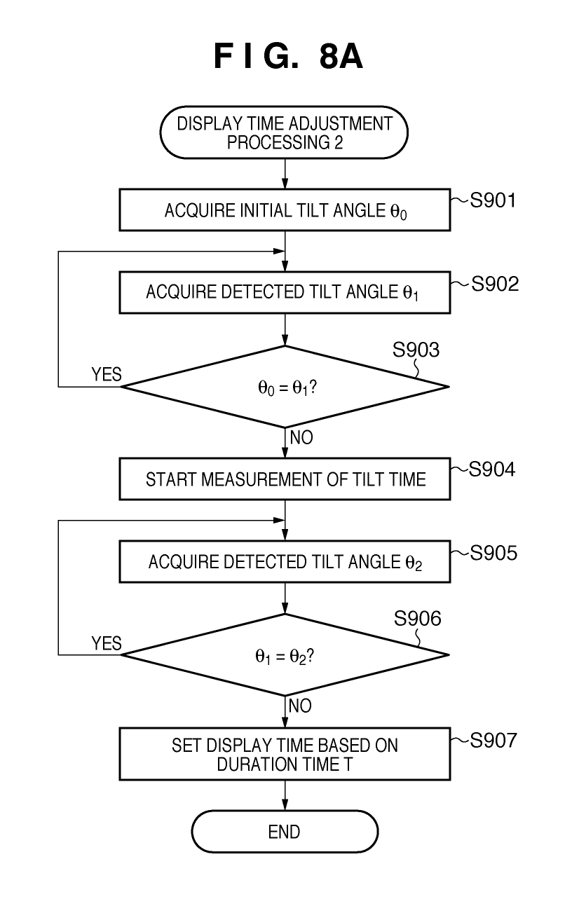

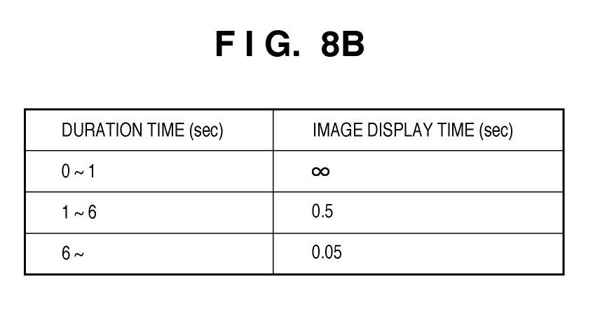

A state duration time after the change in tilt of the digital camera 100 may be measured, and the display time of the image in step S302 may be adjusted according to the duration time. The image display time adjustment processing in this case will be described below with reference to FIGS. 8A and 8B. FIG. 8A is a flowchart showing an example of processing for adjusting the display time of image data in accordance with the duration time of the tilt state (display time adjustment processing 2). FIG. 8B is a table showing the correspondence between the duration times of the tilt state and the display times. A lookup table 910 in FIG. 8B may be stored in advance in the digital camera 100 (for example, the nonvolatile memory 56).

Referring to FIG. 8A, the system controller 50 acquires an angle θ₀ detected by the tilt detector 71 when the touch detector 75 detects a touch in step S901. In step S902, the system controller 50 acquires an angle θ₁ detected later from the tilt detector 71. The system controller 50 calculates in step S903 if the detected angles θ₀ and θ₁ match. Note that this match need not always be a perfect match, and a predetermined error range may be assured. This is because when the user holds the digital camera 100 by hands, a slight vibration is produced due to a hand-shake and the like.

If the detected angles θ₀ and θ₁ match, the process advances to step S904. If they do not match, the process returns to step S902. In step S904, the system controller 50 begins to measure a duration time of the tilt using, for example, an internal software counter. In step S905, the system controller 50 acquires an angle θ₂ further detected by the tilt detector 71. The system controller 50 checks in step S906 if the detected angle θ₂ remains unchanged from the detected angle θ₁. This change can also be determined by assuring a certain error range.

If the detected angle remains unchanged (“YES” in step S906), the process returns to step S905 to continue the processing. On the other hand, if the detected angle changes (“NO” in step S906), the process advances to step S907. In this embodiment, assume that the tilt angle in this case is changed to the previously detected angle θ₀. In step S907, the system controller 50 acquires a display time from the table shown in FIG. 8B based on a measured duration time T, and sets it as the display time of the image data.

In this way, even when the tilt angle is small, a quick image feed operation can be made. As a result, the user hardly misses a desired image due to an excessively large tilt angle.

As described above, the image feed operation using the tilt sensor has been explained taking a digital camera as an example. In the description of this embodiment, two touch sensors are used and are laid out on the right and left sides of the display panel. However, touch sensors may be provided at four, that is, upper, lower, right, and left positions, or at nine positions to cover the full range of the display panel.

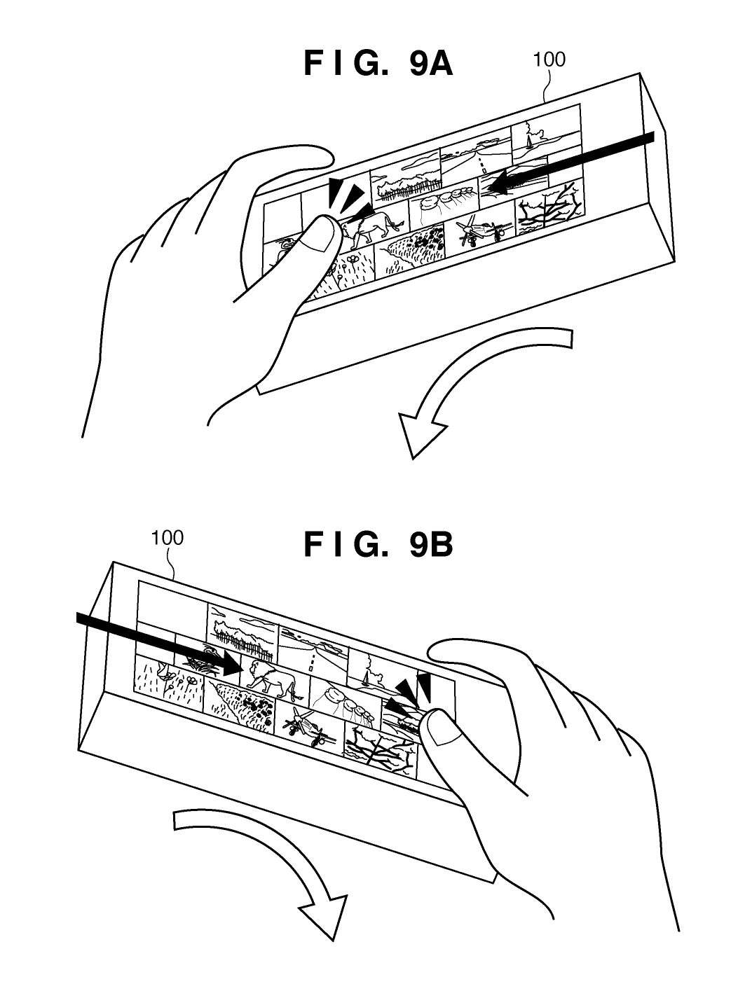

In this case, when images are sequentially displayed over a plurality of rows or columns using thumbnails, as shown in FIGS. 9A and 9B, only thumbnails of images corresponding to a touched row or column may be displayed as a slideshow. In this case, in the checking process in step S304 of the flowchart shown in FIG. 3, not only the right or left touch sensor but also a row or column touch sensor that detects a touch is checked. Then, thumbnail image data that belongs to the row or column that detects a touch are displayed as a slideshow.

In the description of the example of this embodiment, the user can issue an instruction to perform an image feed operation according to the tilt by touching the first or second touch sensor 275R or 275L laid out on the image display unit 28. However, the instruction is not limited to that based on the touch operation. An operation of another operation member can instruct to make an image feed operation according to the tilt as long as that instruction is based on a user's operation. For example, pressing of the right button 256 in place of touching to the first touch sensor 275R and that of the left button 255 in place of touching to the second touch sensor 275L may be designed to be accepted as instructions to make an image feed operation according to the tilt.

This embodiment has explained only image display. For example, respective setting values and the like of the digital camera may be changed by tilting the digital camera by the same method as described above.

### Second Embodiment

The second embodiment will explain an example in which an image feed operation according to the tilt is made when the right button 256 or left button 255 as an image feed button is pressed, and image rotation processing is executed in place of the image feed operation when the image display apparatus is tilted in other cases.

This embodiment will also explain an example in which the present invention is applied to a digital camera as an example of the image display apparatus of this embodiment. Since the hardware arrangement example and outer appearance of the digital camera are the same as those described above using FIGS. 1 and 2A, a repetitive description thereof will be avoided.

The tilt of the digital camera in the second embodiment will be described below. In the first embodiment, the tilt detector 71 detects an angle 8 tilted from a state in which the digital camera is held while the display surface of the image display unit 28 is parallel to the ground level, and faces in a direction opposite to the ground level, that is, faces up, and the detected angle θ is used in an image feed operation according to the tilt. On the other hand, in the second embodiment, the tilt detector 71 detects an angle θ tilted from a state in which the display surface of the image display unit 28 is perpendicular to the ground level (the normal direction to the display surface is perpendicular to the vertical direction), and the top surface (that having the power button 251) of the digital camera 100 is located on the upper side in the vertical direction, and the detected angle θ is used in an image feed operation according to the tilt. Note that the normal to the display surface is a line which is perpendicular to the display surface, and is also perpendicular to the longitudinal direction and widthwise direction of the display surface.

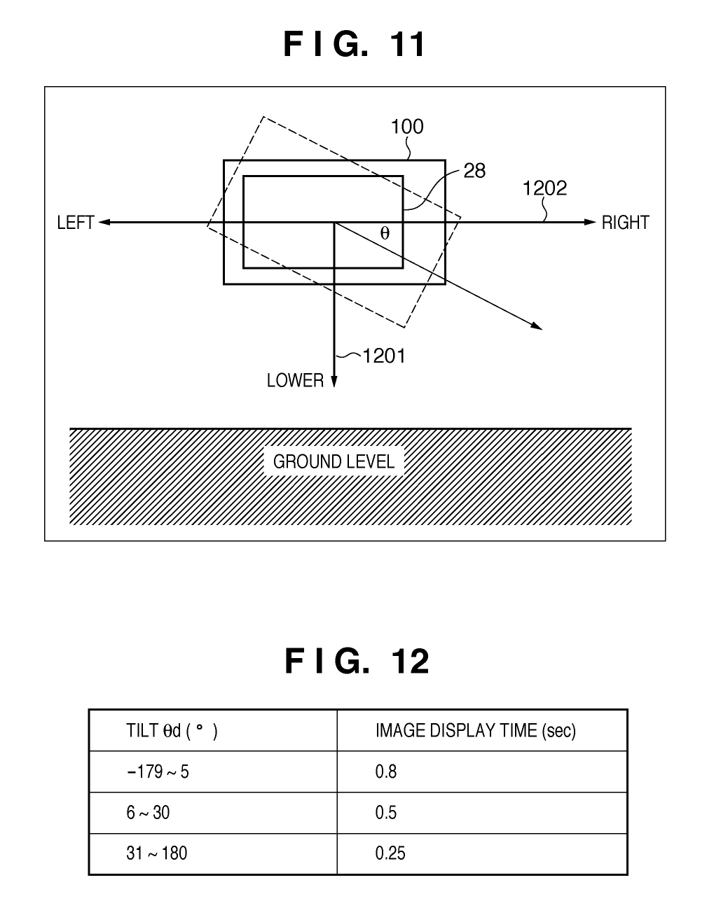

A tilt angle θ used in the image feed operation in the second embodiment will be described below with reference to FIG. 11. FIG. 11 is a view for explaining the tilt of the digital camera 100 in the second embodiment. Referring to FIG. 11, the image display unit 28 of the digital camera 100 is parallel to a panel defined by a vertical direction 1201 and horizontal direction 1202. Then, assume that the digital camera 100 is held so that its bottom surface is located on the ground level side, and its top surface is located on the side opposite to the ground level to sandwich the main body (the solid line in FIG. 11). In this case (the solid line in FIG. 11), assume that a tilt angle θ is 0°.

In this state, when the user lowers the right side (on the side where the direction selection keys are arranged) of the digital camera 100 toward the vertical direction 1201, and raises the left side in a direction opposite to the vertical direction 1201, the digital camera 100 has a tilt angle θ with respect to the horizontal direction 1202. The tilt detector 71 detects this angle θ, and notifies the system controller 50 of the detected angle. Note that even when the display surface is not perpendicular to the ground level, an angle component of a tilt corresponding to this angle θ is used.

The angle θ allows detecting a change in first tilt by assigning a positive sign when the digital camera 100 is tilted clockwise in FIG. 11. Also, the angle θ allows detecting a change in second tilt by assigning a negative sign when the digital camera 100 is tilted counterclockwise in FIG. 11. Note that the signs assigned to the change in first tilt and that in the second tilt may reversed. When a positive sign is assigned to the angle θ, it is assumed that the digital camera 100 is tilted to the right. On the other hand, when a negative sign is assigned to the angle θ, it is assumed that the digital camera 100 is tilted to the left.

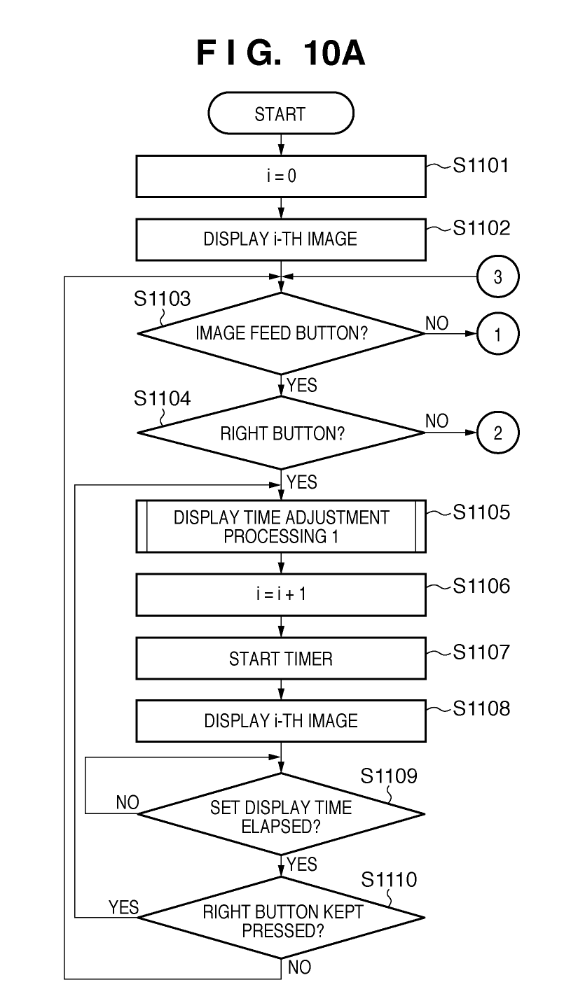

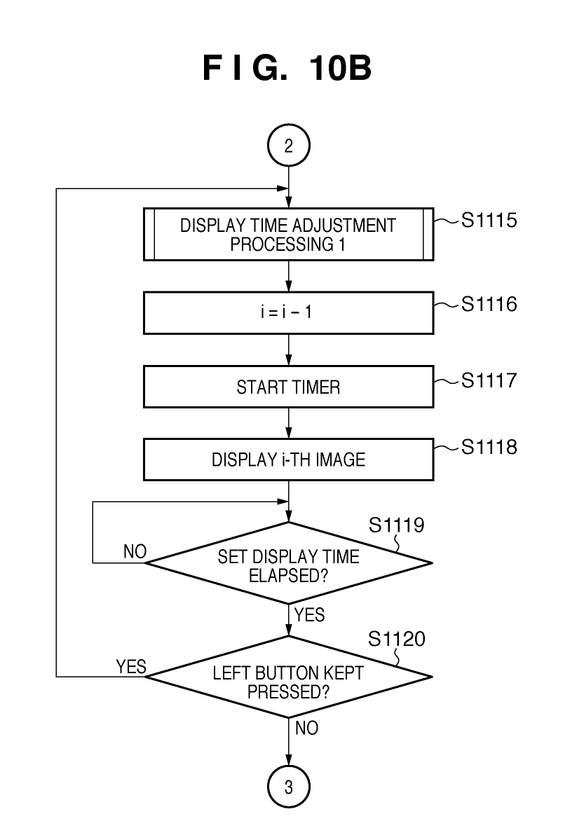

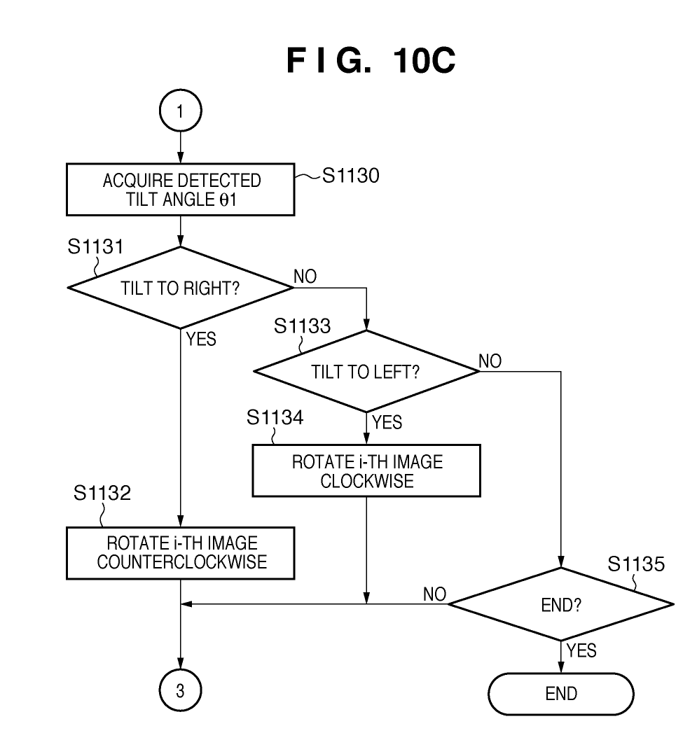

FIGS. 10A to 10C are flowcharts for explaining the image feed operation according to this embodiment. Processing corresponding to this flowchart is implemented when the system controller 50 executes a corresponding processing program stored in the memory 52.

When the digital camera 100 is activated in the play mode, the system controller 50 resets a counter i indicating the display order of images to zero in step S1101. In step S1102, the system controller 50 reads out the 0th image from the memory 30, and displays the readout image. In this case, if the counter of the previously displayed image is recorded on the nonvolatile memory 56, the system controller 50 may extract that counter i, and may display the corresponding image.

The system controller 50 checks in step S1103 if the right button 256 or left button 255 is pressed while the i-th image is displayed. If it is determined that the right button 256 or left button 255 is pressed, the process advances to step S1104; otherwise, the process advances to step S1130.

The system controller 50 checks in step S1104 if the button determined to be pressed in step S1103 is the right button 256. If it is determined that the right button 256 is pressed, the process advances to step S1105; if it is determined that the right button 256 is not pressed, that is, the left button 255 is pressed, the process advances to step S1115.

In step S1105, the system controller 50 executes display time adjustment processing 1 described above using FIG. 7A. That is, the system controller 50 sets a display time T based on a difference angle θ_{d} between an initial tilt angle θ₀ at the time of pressing of the right button and a current tilt angle θ₁. However, in this embodiment, the direction of the angle θ (more specifically, the angles θ₀, θ₁, and θ_{d}) is different from the first embodiment, as described above using FIG. 11. Also, assume that the display time T is determined based on a lookup table shown in FIG. 12 in place of FIG. 7B. Furthermore, assume that when the digital camera 100 is tilted to the right while the right button 256 is pressed, the angle θ has a tilt angle in the positive direction.

After the display time T is set, the system controller 50 increments the counter i in step S1106. In step S1107, the system controller 50 starts a timer for measuring the display time T so as to display the i-th image during only the set display time T. Simultaneously with the start of the timer, the system controller 50 displays the i-th image on the image display unit 28 in step S1108.

The system controller 50 checks in step S1109 if the display time T has elapsed in the timer started in step S1107. If it is determined that the display time T has not elapsed yet, the system controller 50 waits for an elapse of the display time T. If it is determined that the display time T has elapsed, the process advances to step S1110.

The system controller 50 checks in step S1110 if the right button 256 is kept pressed since it was determined in step S1104 that the right button 256 was pressed. If it is determined that the right button 256 is kept pressed, the process returns to step S1105, and the system controller 50 sets the display time T again according to the current tilt angle θ₁. The system controller 50 then repeats the processes in step S1106 and subsequent steps. If NO in step S1110, the process returns to step S1103.

In this way, as long as the right button 256 is kept pressed, the display time T is dynamically changed according to the current tilt, and an image feed (forward feed) operation is made. That is, when the user wants to quicken the image feed operation while pressing the right button 256, he or she further tilts the digital camera 100 to the right; when the user wants to slow down the image feed operation, he or she can reduce the tilt of the digital camera 100 to the right.

On the other hand, if it is determined in step S1104 that the right button 256 is not pressed, that is, that the left button 255 is pressed, the system controller 50 executes the processes in step S1115 and subsequent steps.

In step S1115, the system controller 50 executes display time adjustment processing 1 described above using FIG. 7A. That is, the system controller 50 sets a display time T based on a difference angle θ_{d} between an initial tilt angle θ₀ at the time of pressing of the left button and a current tilt angle θ₁. However, in this embodiment, the direction of the angle θ (more specifically, the angles θ₀, θ₁, and θ_{d}) is different from the first embodiment, as described above using FIG. 11. Also, assume that the display time T is determined based on the lookup table shown in FIG. 12 in place of FIG. 7B. Furthermore, assume that when the digital camera 100 is tilted to the left while the left button 255 is pressed, the angle θ has a tilt angle in the positive direction. That is, when the user lowers the left side of the digital camera 100 toward the ground level, and raises the right side with respect to the ground level, that is, when the user tilts the digital camera counterclockwise, the digital camera 100 has a tilt angle in the positive direction with respect to the horizontal direction as an angle θ. In this step, an angle opposite to that in step S1105 is considered as a positive angle.

After the display time T is set, the system controller 50 decrements the counter i in step S1116. Since the processes in steps S1117 to S1119 are the same as those in steps S1107 to S1109 described above, a repetitive description thereof will be avoided.

The system controller 50 checks in step S1120 if the left button 255 is kept pressed since it was determined in step S1104 that the left button 255 was pressed. If it is determined that the left button 255 is kept pressed, the process returns to step S1115, and the system controller 50 sets the display time T again according to the current tilt angle θ₁. The system controller 50 then repeats the processes in step S1116 and subsequent steps. If NO in step S1120, the process returns to step S1103.

In this way, as long as the left button 255 is kept pressed, the display time T is dynamically changed according to the current tilt, and an image feed (reverse feed) operation is made. That is, when the user wants to quicken the image feed operation while pressing the left button 255, he or she further tilts the digital camera 100 to the left; when the user wants to slow down the image feed operation, he or she can reduce the tilt of the digital camera 100 to the left. If it is determined in step S1103 that neither the right button 256 nor the left button 255 are pressed, the system controller 50 acquires the current tilt angle θ₁ from the tilt detector 71 in step S1130.

The system controller 50 checks in step S1131 based on the current tilt angle θ₁ acquired in step S1130 if the digital camera 100 is tilted to the right through a predetermined angle or more. If it is determined that the digital camera 100 is tilted to the right through a predetermined angle or more, the process advances to step S1132, and the system controller 50 rotates the image i currently displayed on the image display unit 28 in the left direction (counterclockwise) through 90°, and displays the rotated image. As a result, even when the digital camera 100 is tilted (turned), the user can look at the image in the right direction. Upon completion of the process in step S1131, the process returns to step S1103. On the other hand, if it is determined in step S1131 that the digital camera 100 is not tilted to the right through the predetermined angle or more, the process advances to step S1133.

The system controller 50 checks in step S1133 based on the current tilt angle θ₁ acquired in step S1130 if the digital camera 100 is tilted to the left through a predetermined angle or more. If it is determined that the digital camera 100 is tilted to the left through a predetermined angle or more, the process advances to step S1134, and the system controller 50 rotates the image i currently displayed on the image display unit 28 in the right direction (clockwise) through 90°, and displays the rotated image. As a result, even when the digital camera 100 is tilted (turned), the user can look at the image in the right direction. Upon completion of the process in step S1134, the process returns to step S1103. On the other hand, if it is determined in step S1133 that the digital camera 100 is not tilted to the left through the predetermined angle or more, since the digital camera 100 is not tilted to the right or left over a threshold, the process advances to step S1135 without applying the rotation processing.

Note that in the checking processes in steps S1131 and S1133, the reference angle θ₀ is not set unlike in the angle checking processes (steps S1105 and S1115) in case of the image feed operation. Instead, it is simply checked if the angle θ₁ with respect to the parallel direction of the ground level exceeds a certain threshold. This is because the user can attain the rotation operation by only tilting the digital camera without touching any member.

The system controller 50 checks in step S1135 if the user makes an end operation. If it is determined that no end operation is made, the process returns to step S1103; otherwise, the processing in FIG. 10A through FIG. 10C ends.

As described above, according to this embodiment, the continuous image feed operation can be made by keeping pressing the image feed button (i.e., pressing the image feed button for a long period of time). When the user wants to change the image feed speed (switching interval), he or she tilts the digital camera 100 while holding down the image feed button, thus freely and easily changing the image feed speed. When the user tilts (turns) the digital camera when he or she does not press any image feed button, an image is rotated. Hence, the user can look at the image in the right direction irrespective of the orientation of the digital camera. Since the rotation processing is not applied during the image feed operation while the user holds down the image feed button, the user can make the image feed operation without any confusion.

Note that the second embodiment handles the angle θ described using FIG. 11 as a tilt angle. However, the angle θ described using FIG. 2B in the first embodiment may be handled as the tilt angle θ, and may be applied to this embodiment. Furthermore, by combining the angle θ described using FIG. 2B with that described using FIG. 11, the image feed speed may be changed by a tilt in either direction.

The second embodiment may be applied to the image feed operation according to the tilt when the first and or second touch sensor 275R or 275L is kept touched like in the first embodiment in place of the right or left button. Also, upon accepting pressing of the right button 256 or left button 255 in step S1103 in FIG. 10A, guidance display described using FIGS. 4A and 4B of the first embodiment may be made according to the pressed button.

In steps S1105 and S1115 in FIGS. 10A and 10B, display time adjustment processing 1 is executed to set the display time of each image according to a change in tilt angle from the beginning of pressing of the image feed button. Alternatively, display time adjustment processing 2 described above using FIG. 8A may be executed. In this case, the display time of each image is set according to the duration time of a state after change, when the tilt changes from the beginning of pressing of the image feed button.

Furthermore, if it is determined in step S1103 in FIG. 10A that the right button 256 or left button 255 is pressed, it is also checked if the image is rotated at that time. If the image is rotated, the rotation may be canceled. For example, when the user tilts the digital camera 100 to the right through a predetermined angle or more while he or she does not press the right button 256 or left button 255, an image is rotated through 90° in the left direction (counterclockwise) compared to a case in which the digital camera is held at a normal position (step S1131). When the user presses the right button 256 or left button 255 while keeping this tilt, rotation of the image is canceled. That is, the image rotated through 90° counterclockwise is rotated through 90° clockwise, thus returning to an image direction when the digital camera 100 has no tilt. As a result, since the image feed operation is made using images displayed in the same direction irrespective of the orientation of the digital camera 100, the user can browse images without any confusion.

### Other Embodiments

Note that, the invention can be implemented by supplying a software program, which implements the functions of the foregoing embodiments, directly or indirectly to a system or apparatus, reading the supplied program code with a computer of the system or apparatus, and then executing the program code. In this case, so long as the system or apparatus has the functions of the program, the mode of implementation need not rely upon a program.

Accordingly, since the functions of the present invention are implemented by computer, the program code installed in the computer also implements the present invention. In other words, the claims of the present invention also cover a computer program for the purpose of implementing the functions of the present invention.

In this case, so long as the system or apparatus has the functions of the program, the program may be executed in any form, such as an object code, a program executed by an interpreter, or script data supplied to an operating system.

Examples of storage media that can be used for supplying the program are a floppy disk, a hard disk, an optical disk, a magneto-optical disk, a CD-ROM, a CD-R, a CD-RW, a magnetic tape, a non-volatile type memory card, a ROM, and a DVD (DVD-ROM, DVD-R or DVD-RW).

As for the method of supplying the program, a client computer can be connected to a website on the Internet using a browser of the client computer, and the computer program of the present invention or an automatically-installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

It is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Besides the cases where the aforementioned functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-143620, filed May 30, 2008, and No. 2009-033129 filed Feb. 16, 2009, which are hereby incorporated by reference herein in their entirety.

1. An image display apparatus comprising:
display means for displaying image data recorded in a recording medium;
instruction accepting means for accepting an instruction from a user to switch displayed image data according to a tilt of said image display apparatus;
tilt detection means for detecting a tilt of said image display apparatus with respect to a predetermined direction; and
display control means for controlling said display means,
to switch displayed image data in accordance with the tilt detected by said tilt detection means, when said tilt detection means detects the tilt and said instruction accepting means accepts the instruction without rotating the image data displayed on said display means even when said tilt detection means detects the tilt, and
to display image data on said display means with rotation in accordance with the tilt detected by said tilt detection means, when said tilt detection means detects the tilt and said instruction accepting means does not accept the instruction.

2-3. (canceled)

4. The apparatus according to claim 1, wherein said display control means controls said display means to switch displayed image data in accordance with a change in tilt of said image display apparatus with respect to the predetermined direction from the tilt at an accepting timing of the instruction by said instruction accepting means.

5. The apparatus according to claim 4, further comprising setting means for setting a display time for each image data to be switched and displayed in accordance with a change amount of the detected tilt,
wherein said display control means controls said display means to switch displayed image data for every display time set by said setting means.

6. The apparatus according to claim 4, further comprising:
measurement means for measuring a duration time of a state in which said tilt detection means detects the change in tilt; and
setting means for setting a display time for each image data to be switched and displayed in accordance with the duration time measured by said measurement means,
wherein said display control means controls said display means to switch displayed image data for every display time set by said setting means.

7. The apparatus according to claim 1, wherein said display control means controls said display means to stop to switch displayed image data when said instruction accepting means ceases to accept the instruction.

8. The apparatus according to claim 1, wherein said instruction accepting means comprises touch detection means for detecting a user's touch.

9. An image display apparatus comprising:
display means for displaying image data recorded in a recording medium;
first instruction accepting means and second instruction accepting means for respectively accepting an instruction from a user to switch displayed image data according to a tilt of said image display apparatus;
tilt detection means for detecting a tilt of said image display apparatus with respect to a predetermined direction; and
display control means for controlling said display means,
to switch displayed image data in a predetermined display order at a time interval corresponding to a first tilt with respect to a predetermined direction detected by said tilt detection means, when said tilt detection means detects the first tilt and said first instruction accepting means accepts the instruction, and
to switch displayed image data in a reverse order of the predetermined display order at a time interval corresponding to a second tilt in a direction opposite to the one of the first tilt with respect to the predetermined direction, when said tilt detection means detects the second tilt and said second instruction accepting means accepts the instruction.

10. The apparatus according to claim 9, wherein said first instruction accepting means comprises first touch detection means associated with one of sides that define said display means to detect a user's touch,
said second instruction accepting means comprises second touch detection means associated with an opposite side of the one side to detect the touch,
the first tilt is a change in tilt detected when said image display apparatus is tilted so that the one side is separated from the user, and
the second tilt is a change in tilt detected when said image display apparatus is tilted so that the opposite side of the one side is separated from the user.

11. The apparatus according to claim 9, wherein said first instruction accepting means comprises an operation member used to instruct to switch at least one displayed image data in the display order irrespective of whether or not said tilt detection means detects a tilt, and
said second instruction accepting means comprises an operation member used to instruct to switch at least one displayed image data in the reverse order irrespective of whether or not said tilt detection means detects a tilt.

12. The apparatus according to claim 9, wherein the first tilt is a tilt detected when said image display apparatus is held so that a direction of a normal to a display surface of said display means is perpendicular to a vertical direction toward a ground level, and when said image display apparatus is tilted so that one of sides which define said display means and are parallel to the vertical direction approaches the ground level, and
the second tilt is a tilt detected when said image display apparatus is tilted so that an opposite side of the one side approaches the ground level.

13. The apparatus according to claim 1, wherein said display means sequentially displays a plurality of image data, and
said display control means controls said display means to switch only displayed image data of a selected row or a selected column of the plurality of sequentially displayed image data.

14. The apparatus according to claim 1, wherein when said instruction accepting means accepts the instruction, said display control means controls said display means to display an instruction for prompting the user to tilt said image display apparatus.

15. (canceled)

16. A method of controlling an image display apparatus, comprising:
a display step of displaying image data recorded in a recording medium on display means;
an instruction accepting step of accepting an instruction from a user to switch displayed image data according to a tilt of the image display apparatus;
a tilt detection step of detecting a tilt of the image display apparatus with respect to a predetermined direction; and
a display control step of controlling the display means,
to switch displayed image data in accordance with the tilt detected in the tilt detection step, when the tilt is detected in the tilt detection step and the instruction is accepted in the instruction accepting step without rotating the image data displayed on said display means even when said tilt detection means detects the tilt, and
to display image data on the display means with rotation in accordance with the tilt detected in the tilt detection step, when a tilt is detected in the tilt detection step and the instruction is not accepted in the instruction accepting step.

17. A computer program stored in a computer-readable storage medium to make a computer function as an image display apparatus, said image display apparatus comprising:
display means for displaying image data recorded in a recording medium;
instruction accepting means for accepting an instruction from a user to switch displayed image data according to a tilt of said image display apparatus;
tilt detection means for detecting a tilt of said image display apparatus with respect to a predetermined direction; and
display control means for controlling said display means,
to switch displayed image data in accordance with the tilt detected by said tilt detection means, when said tilt detection means detects the tilt and said instruction accepting means accepts the instruction without rotating the image data displayed on said display means even when said tilt detection means detects the tilt, and
to rotate display image data displayed on said display means with rotation in accordance with the tilt detected by said tilt detection means, when said tilt detection means detects the tilt and said instruction accepting means does not accept the instruction.

18-19. (canceled)

20. The apparatus according to claim 9, wherein said display control means controls said display means to rotate the image data displayed on said display means in response to the detection of the tilt by said tilt detection means, when both the first instruction accepting means and the second instruction accepting means do not accept the instruction.

21. A method of controlling an image display apparatus, comprising:
a display step of displaying image data recorded in a recording medium on display means;
an instruction accepting step of accepting an instruction by first instruction accepting means or second instruction accepting means from a user to switch displayed image data according to a tilt of said image display apparatus;
a tilt detection step of detecting a tilt of the image display apparatus with respect to a predetermined direction; and
a display control step of controlling the display means,
to switch displayed image data in a predetermined display order at a time interval corresponding to a first tilt with respect to a predetermined direction detected in the tilt detection step, when the first tilt is detected in the tilt detection step and the first instruction accepting means accepts the instruction, and
to switch displayed image data in a reverse order of the predetermined display order at a time interval corresponding to a second tilt in a direction opposite to the one of the first tilt with respect to the predetermined direction, when the second tilt is detected in the tilt detection step and said second instruction accepting means accepts the instruction.

22. A computer program stored in a computer-readable storage medium to make a computer function as an image display apparatus, said image display apparatus comprising:
display means for displaying image data recorded in a recording medium;
first instruction accepting means and second instruction accepting means for respectively accepting an instruction from a user to switch displayed image data according to a tilt of said image display apparatus;
tilt detection means for detecting a tilt of said image display apparatus with respect to a predetermined direction; and
display control means for controlling said display means,
to switch displayed image data in a predetermined display order at a time interval corresponding to a first tilt with respect to a predetermined direction detected by said tilt detection means, when said tilt detection means detects the first tilt and said first instruction accepting means accepts the instruction, and
to switch displayed image data in a reverse order of the predetermined display order at a time interval corresponding to a second tilt in a direction opposite to the one of the first tilt with respect to the predetermined direction, when said tilt detection means detects the second tilt and said second instruction accepting means accepts the instruction.
